(19) United States
(12) Patent Application Publication
(10) Pub. No.: US 2018/0100350 A1
(43) Pub. Date: Apr. 12, 2018

(54) Cordless Window Shade and Spring Drive System Thereof

(71) Applicant: TEH YOR CO., LTD., Taipei (TW)

(72) Inventors: Chin-Tien HUANG, New Taipei City (TW); Chien-Fong HUANG, City of Industry, CA (US)

(73) Assignee: TEH YOR CO., LTD., Taipei (TW)

(21) Appl. No.: 15/291,227

(22) Filed: Oct. 12, 2016

(51) Int. Cl. E06B 9/322; E06B 9/262; B65H 75/48

(52) U.S. Cl. CPC E06B 9/322; E06B 9/262; E06B 2009/3222; E06B 2009/2627; B65H 75/486

(57) ABSTRACT

A spring drive system for a cordless window shade includes a housing, a rotary drum pivotally connected with the housing and having an inner cavity, a spring shaft connected with the housing coaxial to the rotary drum and extending in the inner cavity of the rotary drum, and a spring disposed in the inner cavity of the rotary drum. The rotary drum has a first and a second circumferential region that surround the inner cavity of the rotary drum, the first and second circumferential regions being respectively connected with the first and second suspension cords. The spring has a first and a second end respectively anchored with the spring shaft and the rotary drum, the spring biasing the rotary drum in rotation to respectively wind the first and second suspension cords around the first and second circumferential regions of the rotary drum.

### BACKGROUND

### 1. Field of the Invention

The present inventions relate to cordless window shades, and spring drive systems used in cordless window shades.

### 2. Description of the Related Art

Many types of window shades are currently available on the market, such as Venetian blinds, roller shades and honeycomb shades. The shade when lowered can cover the area of the window frame, which can reduce the amount of light entering the room through the window and provided increased privacy. Conventionally, the window shade is provided with an operating cord that can be manually actuated to raise or lower a bottom rail of the window shade. The bottom rail can be raised by winding a suspension member around a rotary drum, and lowered by unwinding the suspension member from the rotary drum.

However, there have been concerns that the operating cord of the window shade may pose strangulation threat to children. As a result, cordless window shades have been developed, which use electric motors or spring motors to raise and lower the bottom rail. Spring motors used in window shades generally consist of springs that are operable to apply a torque for keeping the bottom rail at a desired height. However, the conventional assemblies of the spring motors are usually complex, and require multiple moving parts to transmit the spring torque to the rotary drum. This may increase the weight of the spring motor that is provided in the cordless window shade.

Therefore, there is a need for a cordless window shade that has an improved drive system, and can address at least the foregoing issues.

### SUMMARY

The present application describes a cordless window shade and a spring drive system for use with the cordless window shade. In one embodiment, the spring drive system includes a housing, a rotary drum pivotally connected with the housing and having an inner cavity, a spring shaft connected with the housing coaxial to the rotary drum and extending in the inner cavity of the rotary drum, and a spring disposed in the inner cavity of the rotary drum. The rotary drum has a first and a second circumferential region that surround the inner cavity of the rotary drum, the first circumferential region being connected with an end of a first suspension cord, and the second circumferential region being connected with an end of a second suspension cord. The spring has a first and a second end respectively anchored with the spring shaft and the rotary drum, the spring biasing the rotary drum in rotation for respectively winding the first and second suspension cords around the first and second circumferential regions of the rotary drum.

### BRIEF DESCRIPTION OF THE DRAWINGS

FIG. 1 is a perspective view illustrating an embodiment of a cordless window shade;

FIG. 2 is a top view of the window shade shown in FIG. 1;

FIG. 3 is a perspective view illustrating the window shade of FIG. 1 in an expanded or lowered state;

FIG. 4 is a front view illustrating the window shade of FIG. 1 in an expanded or lowered state;

FIG. 5 is a exploded view illustrating a construction of the window shade shown in FIG. 1;

FIG. 6 is an exploded view illustrating a construction of a spring drive system implemented in the window shade;

FIG. 7 is a cross-sectional view illustrating the construction of the spring drive system implemented in the window shade;

FIG. 8 is a schematic view illustrating the spring drive system in a state corresponding to the fully raised or opened configuration of the window shade shown in FIG. 1; and

FIG. 9 is a schematic view illustrating the spring drive system when the window shade is lowered.

### DETAILED DESCRIPTION OF THE EMBODIMENTS

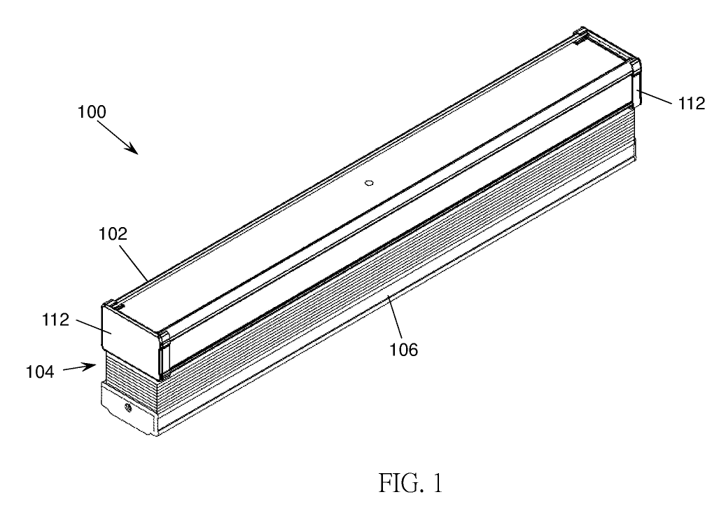

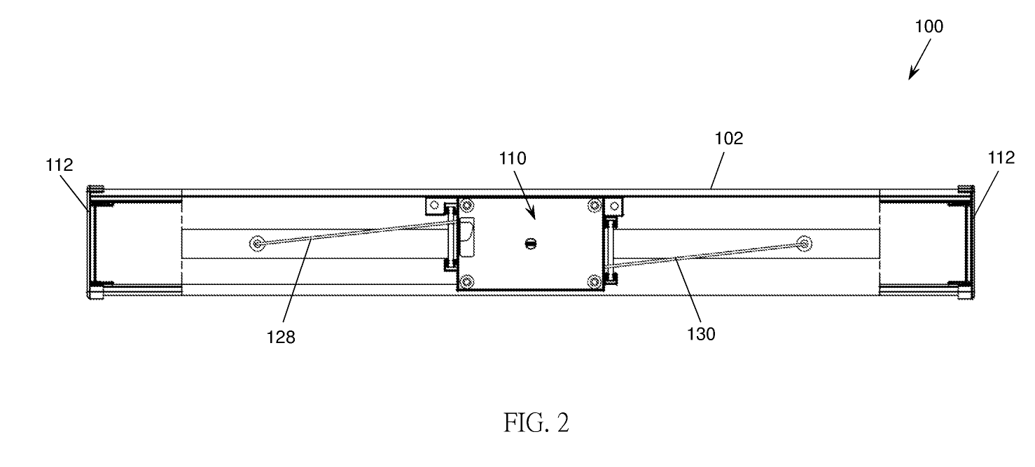

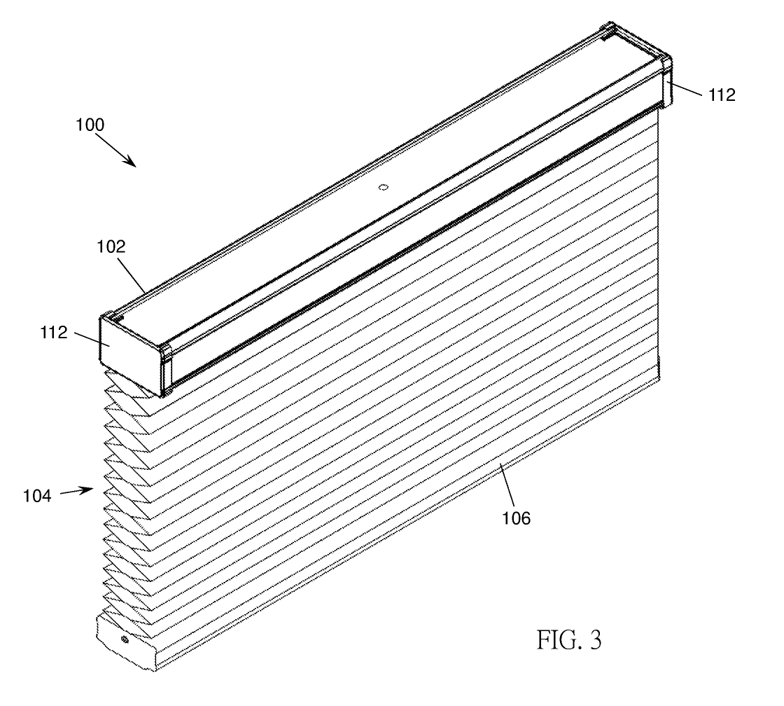

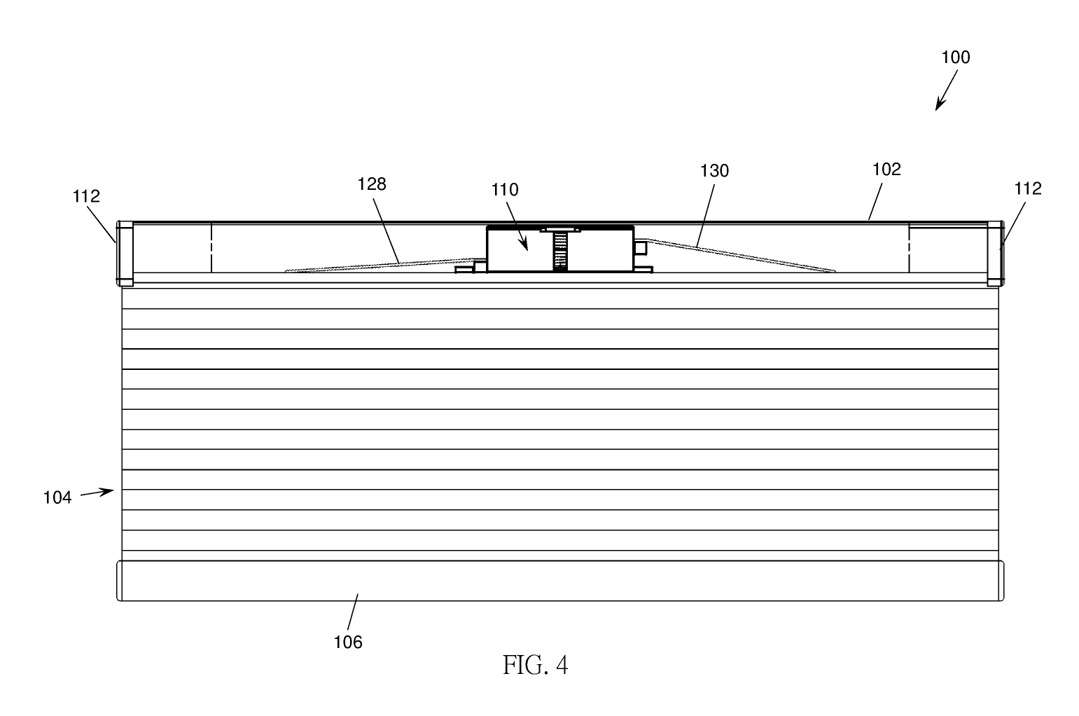

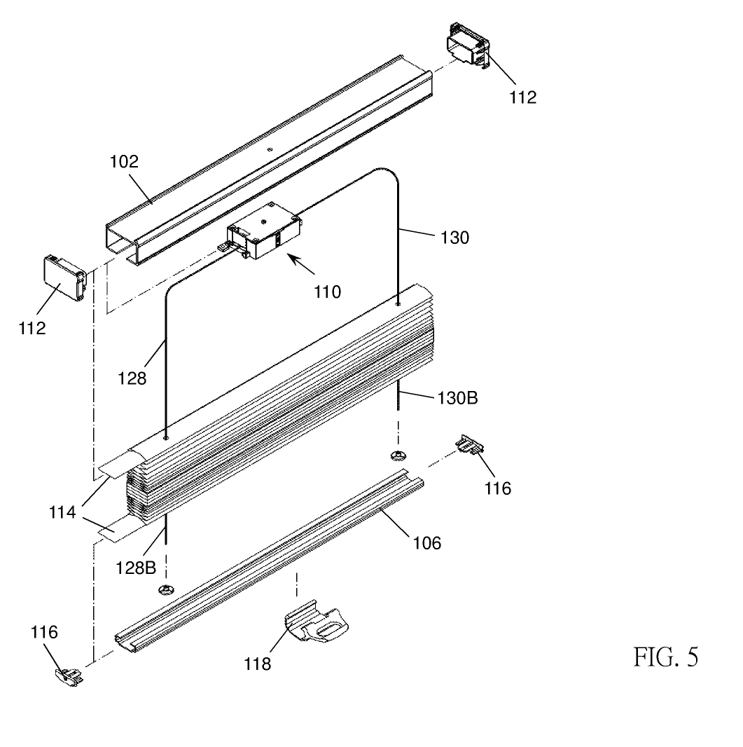

FIG. 1 is a perspective view illustrating an embodiment of a cordless window shade 100, FIG. 2 is a top view illustrating an interior of a head rail 102 of the window shade 100, FIGS. 3 and 4 are respectively perspective and front views illustrating the window shade 100 in an expanded or lowered state, and FIG. 5 is a exploded view illustrating a construction of the window shade 100. “Cordless window shade” as used herein means a window shade having no operating cord exposed for a user's operation. Referring to FIGS. 1-5, the window shade 100 includes a head rail 102, a shading structure 104, a bottom part 106 disposed at a bottom of the shading structure 104, and a spring drive system 110. For clarity, some portion of the head rail 102 is omitted in FIGS. 2 and 4 to better show the spring drive system 110 inside the head rail 102.

The head rail 102 may be of any types and shapes. The head rail 102 may be affixed at a top of a window frame, and the shading structure 104 and the bottom part 106 can be suspended from the head rail 102. Moreover, the head rail 102 can have an inner cavity for receiving the spring drive system 110. The inner cavity of the head rail 102 can be sideways closed by two end caps 112 that are respectively attached to two opposite ends of the head rail 102.

The shading structure 104 is suspended from the head rail 102, and can have any suitable constructions. For example, the shading structure 104 can include a cellular structure defined by a flexible or cloth material. Stiff strips 114 may be respectively assembled with an upper and a lower end of the cellular structure so as to facilitate its attachment to the head rail 102 and the bottom part 106.

The bottom part 106 is disposed at a bottom of the window shade 100, and is movable vertically relative to the head rail 102 to expand and collapse the shading structure 104. The bottom part 106 may be formed as an elongated rail. However, any types of weighing structures may be suitable. In some embodiment, the bottom part 106 may also be formed by a lowermost portion of the shading structure 104. The bottom part 106 may have an inner cavity in which the lower end of the shading structure 104 can be attached. The inner cavity of the bottom part 106 can be sideways closed by two end caps 116 that are respectively attached to two opposite ends of the bottom part 106. Moreover, the bottom part 106 can be fixedly connected with a handle 118 that can be grasped by a user for raising and lowering the bottom part 106.

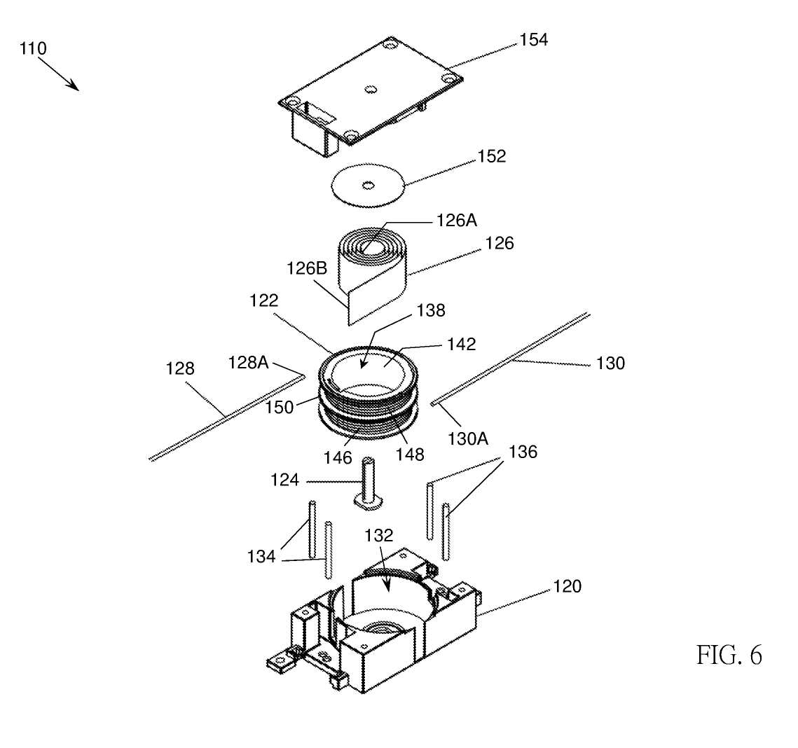

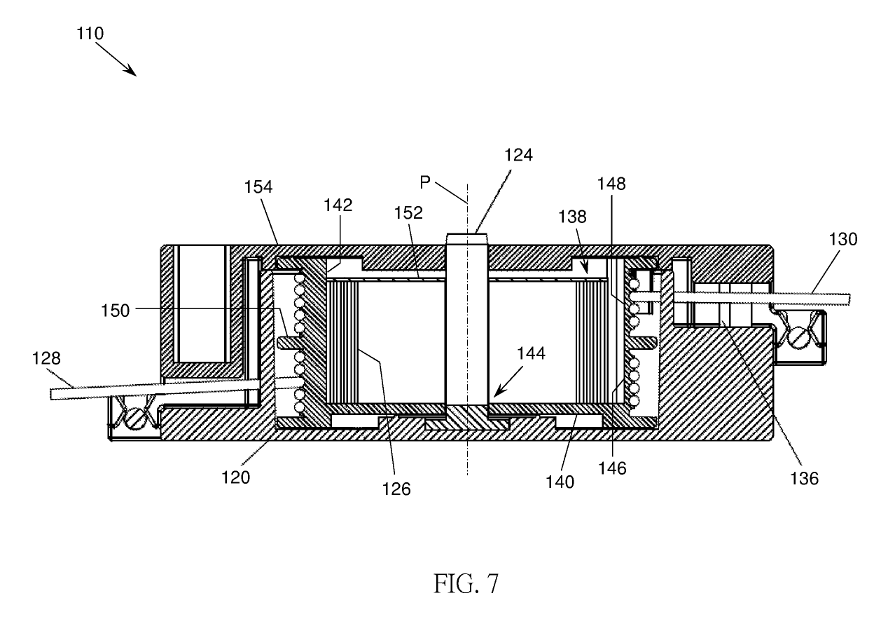

The spring drive system 110 can be affixed with the head rail 102, and can be operatively connected with the bottom part 106. In conjunction with FIG. 5, FIGS. 6 and 7 are respectively exploded and cross-sectional views illustrating a construction of the spring drive system 110. Referring to FIGS. 5-7, the spring drive system 110 can include a housing 120, a rotary drum 122, a spring shaft 124, a spring 126 and two suspension cords 128 and 130. The spring drive system 110 can operate to sustain the shading structure 104 and the bottom part 106 at any desirable height, and urge the rotary drum 122 in rotation for winding the suspension cords 128 and 130 when the bottom part 106 rises upward.

The housing 120 can define a receiving cavity 132 for assembly of the rotary drum 122 and the spring shaft 124. Moreover, the housing 120 can be respectively assembled with guide shafts 134 and 136 disposed outside the receiving cavity 132. In particular, the two guide shafts 134 can be assembled adjacent to each other at a first side of the receiving cavity 132, and the two guide shafts 136 can be assembled adjacent to each other at a second side of the receiving cavity 132 opposite to the side of the guide shafts 134. When the spring drive system 110 is assembled in the window shade 100, the housing 120 can be fixedly attached to the head rail 102.

The rotary drum 122 is placed in the receiving cavity 132, and is pivotally connected with the housing 120 about a pivot axis P. The rotary drum 122 has an inner cavity 138 that is delimited at least partially by a base 140 and a sidewall 142 projecting from the base 140. The base 140 is substantially perpendicular to the pivot axis P of the rotary drum 122, and can have an opening 144 through which passes the pivot axis P. The sidewall 142 can be generally perpendicular to the base 140, and can have a generally cylindrical shape. Moreover, the rotary drum 122 includes two circumferential regions 146 and 148 that respectively surround the inner cavity 138, and are separated from each other by an annular ridge 150. In one example of implementation, the rotary drum 122, including the base 140, the sidewall 142, the circumferential regions 146 and 148 and the annular ridge 150, can be formed integrally as a single part.

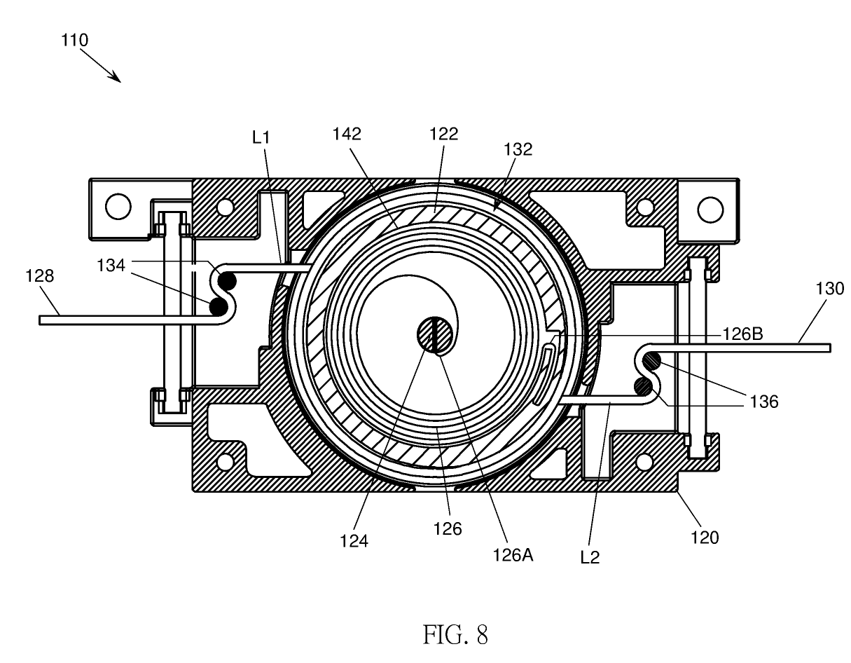

The suspension cord 128 has an end 128A (better shown in FIG. 6) anchored with the circumferential region 146 of the rotary drum 122, another opposite end 128B (better shown in FIG. 5) anchored with the bottom part 106, and is guided for travel through the two guide shafts 134 at a side of the rotary drum 122. The other suspension cord 130 has an end 130A (better shown in FIG. 6) anchored with the circumferential region 148 of the rotary drum 122, another opposite end 130B (better shown in FIG. 5) anchored with the bottom part 106, and is guided for travel through the two guide shafts 136 at the other opposite side of the rotary drum 122. The two sets of guide shafts 134 and 136 can be disposed symmetric relative to the pivot axis P of the rotary drum 122, such that a portion L1 of the suspension cord 128 extending between the rotary drum 122 and the two guide shafts 134 is generally parallel to a portion L2 of the suspension cord 130 extending between the rotary drum 122 and the two guide shafts 136 (the portions L1 and L2 are better shown in FIG. 8).

The spring shaft 124 is disposed in the receiving cavity 132, and is fixedly connected with the housing 120 coaxial to the rotary drum 122. In other words, the spring shaft 124 extends generally along the pivot axis P of the rotary drum 122. The spring shaft 124 can extend through the opening 144 of the base 140 into the inner cavity 138 of the rotary drum 122.

The spring 126 can be a ribbon spring, and is disposed in the inner cavity 138 of the rotary drum 122. The spring 126 has an end 126A anchored with the spring shaft 124, and another end 126B anchored with the rotary drum 122 (e.g., by attachment to the sidewall 142 of the rotary drum 122), the spring 126 coiling around the spring shaft 124. The spring 126 thereby assembled can bias the rotary drum 122 in rotation to respectively wind the two suspension cords 128 and 130 around the two circumferential regions 146 and 148 of the rotary drum 122. A washer 152 can be disposed adjacent to the spring 126 for restrictedly positioning the spring 126 in the inner cavity 138 of the rotary drum 122. After the rotary drum 122 and spring 126 are disposed in the receiving cavity 132, a lid 154 can be fastened to the housing 120 to cover the receiving cavity 132 of the housing 120 and the inner cavity 138 of the rotary drum 122.

Once the spring drive system 110 is assembled with the window shade 100, the pivot axis P of the rotary drum 122 can extend generally vertically, and the suspension cords 128 and 130 can respectively extend through openings provided in the shading structure 104 for connection with the bottom part 106.

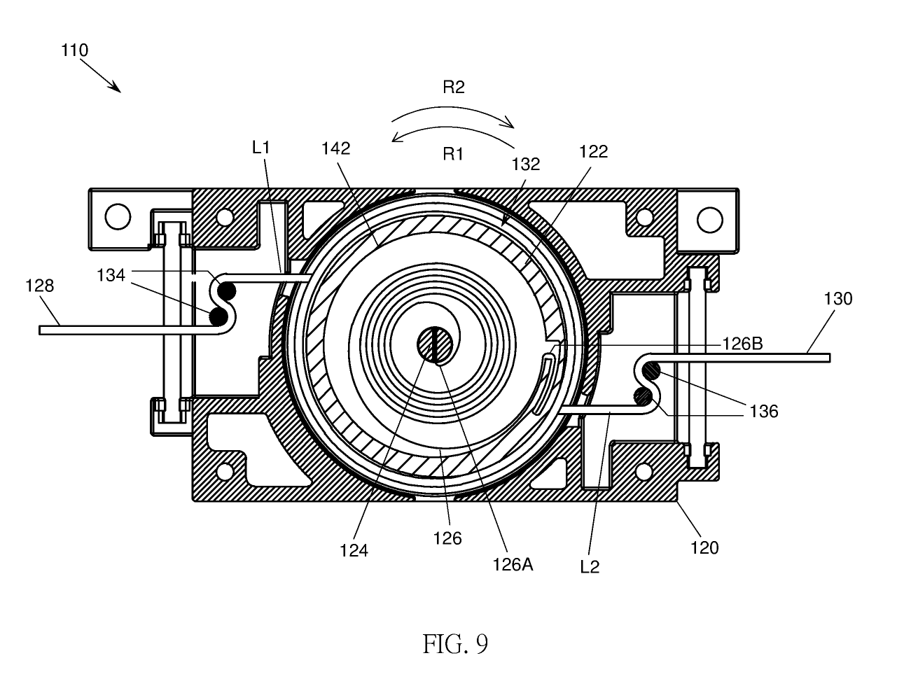

In conjunction with FIGS. 1-7, reference is hereinafter made to FIGS. 8 and 9 to describe exemplary operation of the spring drive system 110 of the window shade 100. FIG. 8 is a schematic view illustrating the spring drive system 110 in a state corresponding to the fully raised or opened configuration of the window shade 100 shown in FIG. 1. Referring to FIGS. 1, 6, 7 and 8, while the window shade 100 is fully raised or opened, the two suspension cords 128 and 130 are substantially wound around the circumferential regions 146 and 148 of the rotary drum 122. Moreover, the coils of the spring 126 are closely adjacent to one another, and are located adjacent to the sidewall 142 of the rotary drum 122. The biasing force applied by the spring 126 on the rotary drum 122 can counteract a weight exerted on the bottom part 106, so that the rotary drum 122 can be kept stationary. Accordingly, the bottom part 106 can remain in position close to the head rail 102 with the shading structure 104 collapsed between the head rail 102 and the bottom part 106.

Referring to FIGS. 3, 6, 7 and 9, when the bottom part 106 is lowered away from the head rail 102 to expand at least partially the shading structure 104, the suspension cords 128 and 130 respectively unwind from the circumferential regions 146 and 148 of the rotary drum 122, which drives rotation of the rotary drum 122 relative to the spring shaft 124 and the housing 120 in a direction R1. As a result, the end 126B of the spring 126 that is anchored with the rotary drum 122 is urged to move in the same direction R1, which causes the coils of the spring 126 to displace away from the sidewall 142 and toward the spring shaft 124.

Once the bottom part 106 is released at a desired height, the biasing force applied by the spring 126 on the rotary drum 122 can counteract a weight exerted on the bottom part 106. As a result, the rotary drum 122 can be kept stationary, and the bottom part 106 can remain stationary at the desired position.

For raising the bottom part 106, an operator can manually push the bottom part 106 upward to collapse at least partially the shading structure 104. While the bottom part 106 rises toward the head rail 102, the spring 126 biases the rotary drum 122 to rotate about the pivot axis P in a direction R2 opposite to the direction R1 to respectively wind the two suspension cords 128 and 130 around the circumferential regions 146 and 148 of the rotary drum 122.

The spring drive system described herein can be implemented in a cost-effective manner, and is suitable for use with various types of window shades including, without limitation, honeycomb shades (as shown herein), Venetian blind, and window shades including a plurality of slats distributed vertically and parallel to one another. Moreover, the spring drive system requires less components parts and is compact in size, which can advantageously reduce the overall weight of the window shade.

Realizations of the structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. A spring drive system for a window shade, comprising:
a housing;
a rotary drum pivotally connected with the housing, the rotary drum having a first and a second circumferential region that surround an inner cavity of the rotary drum, the first circumferential region being connected with an end of a first suspension cord, and the second circumferential region being connected with an end of a second suspension cord;
a spring shaft connected with the housing coaxial to the rotary drum, the spring shaft extending in the inner cavity of the rotary drum; and
a spring disposed in the inner cavity of the rotary drum, the spring having a first and a second end respectively anchored with the spring shaft and the rotary drum, the spring biasing the rotary drum in rotation for respectively winding the first and second suspension cords around the first and second circumferential regions of the rotary drum.

2. The spring drive system according to claim 1, wherein the first and second suspension cords respectively extend at two opposite sides of the rotary drum.

3. The spring drive system according to claim 1, wherein the rotary drum has a base provided with an opening, and the spring shaft is fixedly connected with the housing and extends through the opening into the inner cavity of the rotary drum.

4. The spring drive system according to claim 3, wherein the rotary drum further has a sidewall projecting generally perpendicular from the base, and the second end of the spring is attached to the sidewall of the rotary drum.

5. The spring drive system according to claim 1, wherein the first and second circumferential regions are separated from each other by an annular ridge.

6. The spring drive system according to claim 5, wherein the rotary drum, including the first and second circumferential regions and the annular ridge, is formed integrally as a single part.

7. The spring drive system according to claim 1, wherein the rotary drum is disposed in a receiving cavity of the housing, and the housing is respectively assembled with two first and two second guide shafts respectively disposed outside the receiving cavity, the first suspension cord being guided for travel through the first guide shafts and the second suspension cord being guided travel through the second guide shafts.

8. The spring drive system according to claim 7, wherein a first portion of the first suspension cord extending between the rotary drum and the first guide shafts is generally parallel to a second portion of the second suspension cord extending between the rotary drum and the two second guide shafts.

9. The spring drive system according to claim 1, wherein the spring is a ribbon spring.

10. A cordless window shade comprising:
a head rail;
a shading structure suspended from the head rail;
a bottom part connected with a lower end of the shading structure; and
the spring drive system according to claim 1, the housing of the spring drive system being affixed with the head rail, the first and second suspension cords further being respectively affixed with the bottom part, the spring of the spring drive system being configured to counteract a weight applied on the bottom part for sustaining the bottom part in a stationary position.

11. The cordless window shade according to claim 10, wherein the spring biases the rotary drum to rotate for winding the first and second suspension cords when the bottom part rises toward the head rail.

12. The cordless window shade according to claim 10, wherein the rotary drum is rotatable relative to the housing about a pivot axis that extends generally vertically.
